(19) United States
(12) Patent Application Publication
(10) Pub. No.: US 2014/0295820 A1
(43) Pub. Date: Oct. 2, 2014

(54) METHOD AND APPARATUS FOR EFFECTIVELY REDUCING POWER CONSUMPTION OF TERMINAL IN MOBILE COMMUNICATION SYSTEM

(71) Applicant: Samsung Electronics Co., Ltd., Suwon-si, Gyeonggi-do (KR)

(72) Inventors: Sang Bum Kim, Suwon-si (KR); Soeng Hun Kim, Yongin-si (KR)

(73) Assignee: Samsung Electronics Co., Ltd, Suwon-si, Gyeonggi-do (KR)

(21) Appl. No.: 14/353,604

(22) PCT Filed: Oct. 29, 2012
(86) PCT No.: PCT/KR2012/008936

§ 371 Date: Apr. 23, 2014

Related U.S. Application Data
(60) Provisional application No. 61/552,114, filed on Oct. 27, 2011.
(60) Provisional application No. 61/563,345, filed on Nov. 23, 2011.
(60) Provisional application No. 61/658,617, filed on Jun. 12, 2012.

(51) Int. Cl. H04W 52/02; H04W 24/02

(52) U.S. Cl. CPC H04W 52/0225; H04W 24/02
USPC 455/418

(57) ABSTRACT

The present disclosure relates to a method and apparatus for effectively reducing power consumption of a terminal in a mobile communication system. A method of controlling a discontinuous reception operation of a signal for a terminal in a wireless communication system includes the steps of: measuring velocity-related information of the terminal; transmitting the measured velocity-related information to a base station; receiving from the base station, in response to the transmission of the velocity-related information, discontinuous reception operation set information for a variable discontinuous reception operation; and performing the discontinuous reception operation according to the received discontinuous reception operation set information.

### TECHNICAL FIELD

The present disclosure relates to a mobile communication system and, in particular, to a method and apparatus for reducing power consumption of a terminal efficiently.

### BACKGROUND ART

Mobile communication systems have been developed to provide mobile users with communication services. With the rapid advance of technologies, the mobile communication systems have evolved to the level capable of providing high speed data communication service beyond the early voice-oriented services.

Recently, standardization for a Long Term Evolution (LTE) system, as one of the next-generation mobile communication systems, is underway in the 3^{rd} Generation Partnership Project (3GPP). LTE is a technology designed to provide high speed packet-based communication of up to 100 Mbps and aims at commercial deployment around 2010 timeframe. In order to accomplish the aim, a discussion is being held on several schemes: one scheme for reducing the number of nodes located in a communication path by simplifying a configuration of the network, and another scheme for maximally approximating wireless protocols to wireless channels.

Meanwhile, unlike voice service, the data service is provided on the resource determined according to the data amount to be transmitted and channel condition. Accordingly, the wireless communication system, especially cellular communication, is provided with a scheduler manages transmission resource allocation in consideration of the required resource amount, channel condition, data amount, etc. This is the fact in the LTE system as the next generation mobile communication system, and the scheduler located at the base station manages the transmission resource allocation.

Recent studies are focused on the LTE-Advanced (LTE-A) for improving data rate with the adaptation of several new techniques to legacy LTE system. In Release 11, Diverse Data Application (DDA) has been introduced as a Work Item (WI) for reducing power consumption of terminal. This WI is focused on adapting DRX configuration to the traffic characteristics and minimizing signaling overhead in an environment where various traffic types coexist in order to optimize power consumption of the terminal.

### DISCLOSURE OF INVENTION

### Technical Problem

The present disclosure aims to provide a method and apparatus for adapting DRX configuration to the traffic characteristics and minimizing signaling overhead to optimize power consumption of a terminal.

### Solution to Problem

In accordance with an aspect of the present disclosure, a discontinuous reception control method of a terminal in a wireless communication system includes measuring speed-related information of the terminal, transmitting the measured speed-related information to a base station, receiving discontinuous reception configuration information for dynamic discontinuous reception operation of the terminal from the base station in response to the speed-related information of the terminal, and performing the discontinuous reception according to the received discontinuous reception configuration information.

In accordance with another aspect of the present disclosure, a terminal for controlling discontinuous reception in a wireless communication system includes a transceiver which transmits and receives to and from a base station and a controller which controls measuring speed-related information of the terminal, transmitting the measured speed-related information to a base station, receiving discontinuous reception configuration information for dynamic discontinuous reception operation of the terminal from the base station in response to the speed-related information of the terminal, and performing the discontinuous reception according to the received discontinuous reception configuration information.

### Advantageous Effects of Invention

According to various embodiments of the present disclosure, it is possible to change the DRX configuration of the terminal adaptively and minimizing signaling overhead to optimize power consumption of the terminal.

### BRIEF DESCRIPTION OF DRAWINGS

FIG. 1 is a diagram illustrating DRX operation.

FIG. 2 is a diagram illustrating an improved DRX operation for reducing power consumption according to an embodiment of the present disclosure.

FIG. 3 is a signal flow diagram illustrating information exchange between a terminal and a base station before the dynamic DRX operation according to the first embodiment.

FIG. 4 is a flowchart illustrating the operation procedure of the terminal according to the first embodiment.

FIG. 5 is a flowchart illustrating the terminal operation when the TA timer expires.

FIG. 6 is a flowchart illustrating another terminal operation when new data transmission/reception starts after long absence of data transmission/reception.

FIG. 7 is a flowchart illustrating terminal operation according to the third embodiment.

FIG. 8 is a flowchart illustrating the operation procedure of the base station according to the third embodiment.

FIG. 9 is a diagram illustrating PDCCH monitoring operation after D-SR transmission.

FIG. 10 is a diagram illustrating the concept of the disclosure according to the fourth embodiment.

FIG. 11 is a flowchart illustrating the operation procedure of the terminal according to the fourth embodiment.

FIG. 12 is a signal flow diagram illustrating signal flows among the terminal and macro and pico cells according to the fifth embodiment.

FIG. 13 is a flowchart illustrating the operation procedure of the terminal according to the fifth embodiment.

FIG. 14 is a flowchart illustrating the operation procedure of the macro cell base station according to the fifth embodiment.

FIG. 15 is a flowchart illustrating the operation procedure of the pico cell base station according to the fifth embodiment.

FIG. 16 is a block diagram illustrating the terminal of the present disclosure.

FIG. 17 is a signal flow diagram illustrating entire operation between a base station and a terminal according to the third embodiment.

FIG. 18 is a flowchart illustrating another operation procedure of the terminal according to the fifth embodiment.

FIG. 19 is a block diagram illustrating the base station to which the present disclosure is applied.

### MODE FOR THE INVENTION

Exemplary embodiments of the present disclosure are described with reference to the accompanying drawings in detail. The same reference numbers are used throughout the drawings to refer to the same or like parts. Detailed description of well-known functions and structures incorporated herein may be omitted to avoid obscuring the subject matter of the present disclosure.

Although the description is directed to Advanced E-UTRA (or LTE-A) supporting carrier aggregation, it will be understood by those skilled in the art that the present disclosure can be applied even to other communication systems having the similar technical background and channel format, with a slight modification, without departing from the spirit and scope of the present disclosure.

The present disclosure relates to a method and apparatus for reducing power consumption of a terminal effectively in a mobile communication system. In smartphone environment handling of various types of data traffic, there is a need of a method for optimizing power consumption of the terminal in adaptation to the traffic characteristics. The present disclosure proposes the following approaches for optimizing the power consumption of the terminal.
Adaptive DRX configuration (first embodiment)
Fast acquisition of channel status information in resuming transmission/reception (second embodiment)
RRC connection release in case where mobility problem occur to the terminal operating in the RRC connected state for long time without data transmission/reception (third embodiment)
PDCCH monitoring restriction until receiving scheduling information since D-SR transmission (fourth embodiment)
method for avoiding frequent handover failure between macro and pico cells (fifth embodiment)

### First Embodiment

In the LTE system, DRX is adopted to minimize power consumption of the terminal. The terminal usually has to monitor the channel to detect the data addressed it. However, if the terminal is monitoring the channel always, this causes significant power consumption. If the terminal monitors the channel to detect the data addressed to in during predetermined period, it is possible to reduce the power consumption of the terminal. Such a technique is referred to as Discontinuous Reception (DRX).

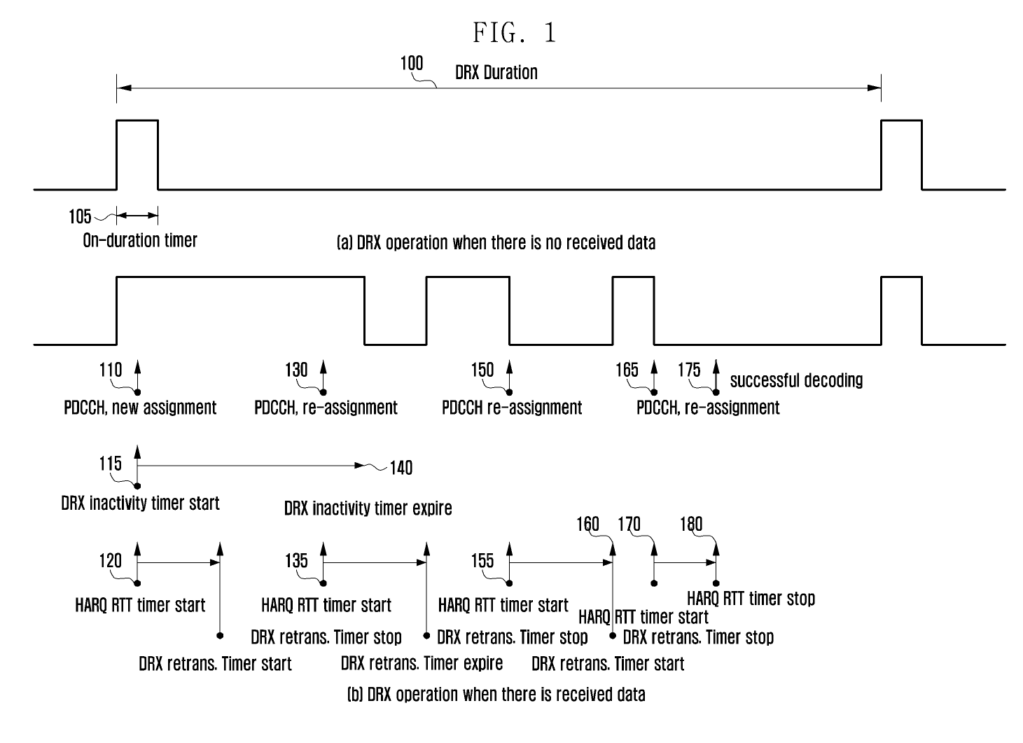

FIG. 1 is a diagram illustrating DRX operation.

Part (a) of FIG. 1 is a diagram illustrating the terminal operation when there is no received data.

The terminal monitors PDCCH as the control channel during predetermined time period but not all the time. A DRX cycle 100 includes specific time duration for monitoring PDCCH which is counted by an On-duration timer 105 periodically. That is, the terminal starts the On-duration timer at every DRX cycle to monitor PDCCH before the expiry of the timer. The DRX cycle and the on-duration timer value are provided to the terminal through a dedicated RRC message. The base station knows the DRX cycle and On-duration timer value of each terminal and, if any data addressed to a certain terminal occurs, transmits PDCCH including the scheduling information to the corresponding terminal for the time when the on-duration timer is running. If PDCCH includes the scheduling information to one terminal, the DRX is configured such that the channel monitoring time of the terminal extends with several timers.

Part (b) of FIG. 1 is a diagram illustrating DRX operation in the case that PDCCH includes new scheduling information.

If the PDCCH includes the scheduling information to the corresponding terminal for the time when the on-duration timer of the terminal is running, the terminal starts DRX inactivity timer 115 and HARQ RTT timer 120 immediately at operation 110.

The active time of the terminal is expended for the time when the DRX inactivity timer is running. That is, the terminal continues monitoring PDCCH while the DRX inactivity timer is running. If the scheduling information is received on the PDCCH, the HARQ RTT timer starts.

There is no need of monitoring PDCCH before receiving new scheduling information for retransmission since the terminal has transmitted NACK information corresponding to the data received from the base station. With the use of the HARQ RTT timer, the terminal skips monitoring PDCCH for the corresponding duration. That is, the HARQ RTT timer value is determined in consideration of Round Trip Time (RTT) in HARQ operation. However, if other timers, i.e. DRX inactivity timer and on-duration timer are running, the terminal stays in the active state although the HARQ RTT timer is running.

If the HARQ RTT timer expires and it fails to decode the data in the soft buffer (or buffer), the DRX retransmission timer 125 starts. If the DRX retransmission timer starts, the terminal stays in the active state. If retransmission scheduling information is received before the expiry of the DRX retransmission timer at operation 130, the UE starts the HARQ RTT timer and stops the DRX retransmission timer at operation 135.

At operation 140, the DRX inactivity timer expires and only the HARQ RTT timer is running such that the terminal transitions to idle state. If the HARQ RTT timer expires without decoding data correctly at operation 145, the DRX retransmission timer starts again. If scheduling information is received before the expiry of the DRX retransmission timer at operation 150, the UE starts the HARQ RTT timer and ends the DRX retransmission timer at operation 155. If it succeeds to decode the data in the soft buffer at operation 175, the HARQ RTT timer is terminated.

Although DRX is good enough to reduce power consumption of the terminal, there is a room for improving the power conservation effect by controlling the DRX operation and setting values dynamically in adaptation to the traffic characteristics.

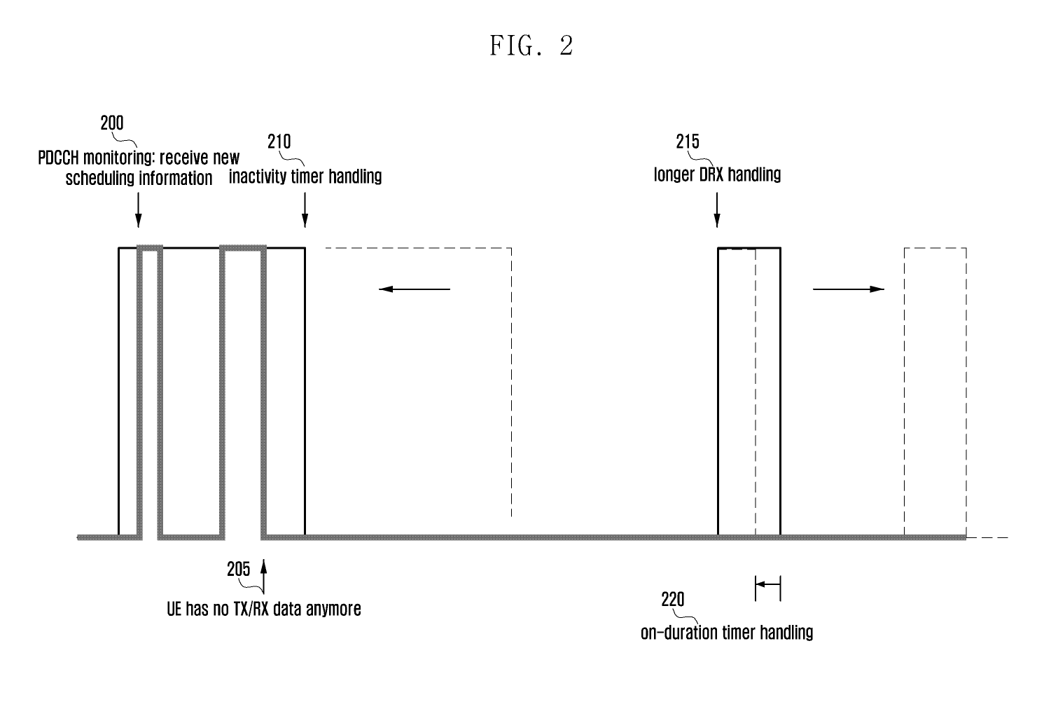

FIG. 2 is a diagram illustrating an improved DRX operation for reducing power consumption according to an embodiment of the present disclosure.

If the scheduling information is received at operation 200 and it is determined that there is no data to transmit/receive any more at operation 205, the terminal puts the expiry of the DRX inactivity timer which has started at operation 200 forward, elongates the next DRX cycle arriving at operation 215 or applies shorter on-duration at operation 220 to further reduce power consumption.

In order to operate as above, there is a need of a mechanism in which the terminal notifies the base station of the current terminal traffic condition and current inappropriate DRX configuration. Also, there is a need of a mechanism for notifying the terminal of the DRX configuration capable of further reducing power consumption. The present disclosure proposes such mechanisms.

The conventional DRX configuration is classified into two categories that applied selectively depending on the situation. That is, one of the short DRX and long DRX is notified to the terminal in advance through an RRC connection reconfiguration message.

The long DRX has a DRX cycle longer than that of the short DRX, but the related parameter values are not differentiated between long DRX and short DRX. The default configuration is the long DRX and, if necessary, the short DRX is triggered With Media Access Control (MAC) CE. The short DRX is changed for the long DRX automatically after being applied for predetermined time duration.

Accordingly, in consideration of reduction of power consumption, it is inappropriate to apply the conventional DRX configuration mechanism in various aspects. First, the maximum DRX cycle is restricted to the long DRX cycle. There may be a need of a longer DRX cycle for further reduction of power consumption. In order to reduce power consumption more effectively, there is a need of adjusting the DRX inactivity timer and on-duration timer depending on the situation as well as DRX cycle as described above. The conventional DRX mechanism allows the base station to trigger switching from the long DRX to the short DRX, but the switching from short DRX to the long DRX depends on a timer. In order to improve the power conservation, however, it is necessary to allow for switching from the short DRX to the long DRX or the longer DRX with more power conservation effect.

Finally, the conventional DRX configuration switching depends on the determination of the based station without input of the terminal. However, it is necessary to notify of the data traffic condition of the terminal to achieve more effective reduction of power consumption.

The first embodiment proposes a method for a terminal to switch DRX configuration autonomously to support rigid mobility as well as reduce power consumption.

For example, the long DRX cycle is capable of reducing power consumption of the terminal but increases the channel measurement period so as to be likely to miss out handover timing, resulting in handover failure. Such a problem may be solved in such a way of adjusting the DRX parameter values dynamically in adaptation to the situation.

In the present embodiment, the base station generates configuration information based on the assistance information provided by the terminal in advance and sends the terminal the configuration information. The terminal performs DRX operation dynamically based on the configuration information.

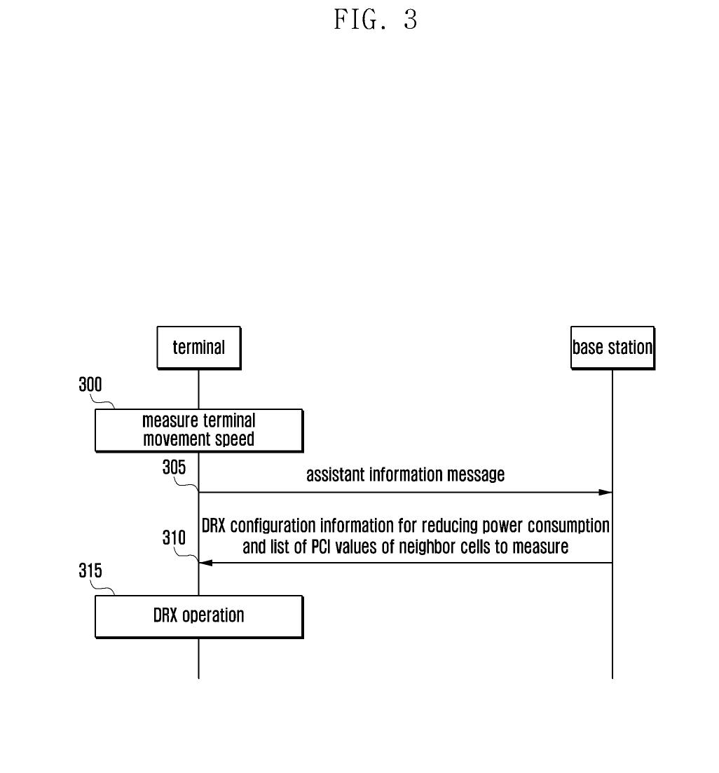

FIG. 3 is a signal flow diagram illustrating information exchange between a terminal and a base station before the dynamic DRX operation according to the first embodiment. The terminal measures the terminal speed at operation 300 and reports the terminal speed-related information to the base station at operation 305. The terminal speed-related information may include DRX cycle length capable of being considered at the current speed of the terminal and the information indicating whether the current speed of the terminal is in or out of a predetermined threshold range. The base station sends the terminal the control information for use in dynamic DRX operation at operation 310. The control information may include short cycle on-duration timer (on DurationTimerShort), long cycle on duration timer (on DurationTimerLong), short cycle DRX inactivity timer (drx-inactivityTimerShort), long cycle drx-inactivity timer (drx-inactivityTimerLong), short DRX cycle (drx-shortCycle), long DRX cycle (DRX-LongCycle), and HARQ retransmission timer (harq-retransmissionTimer).

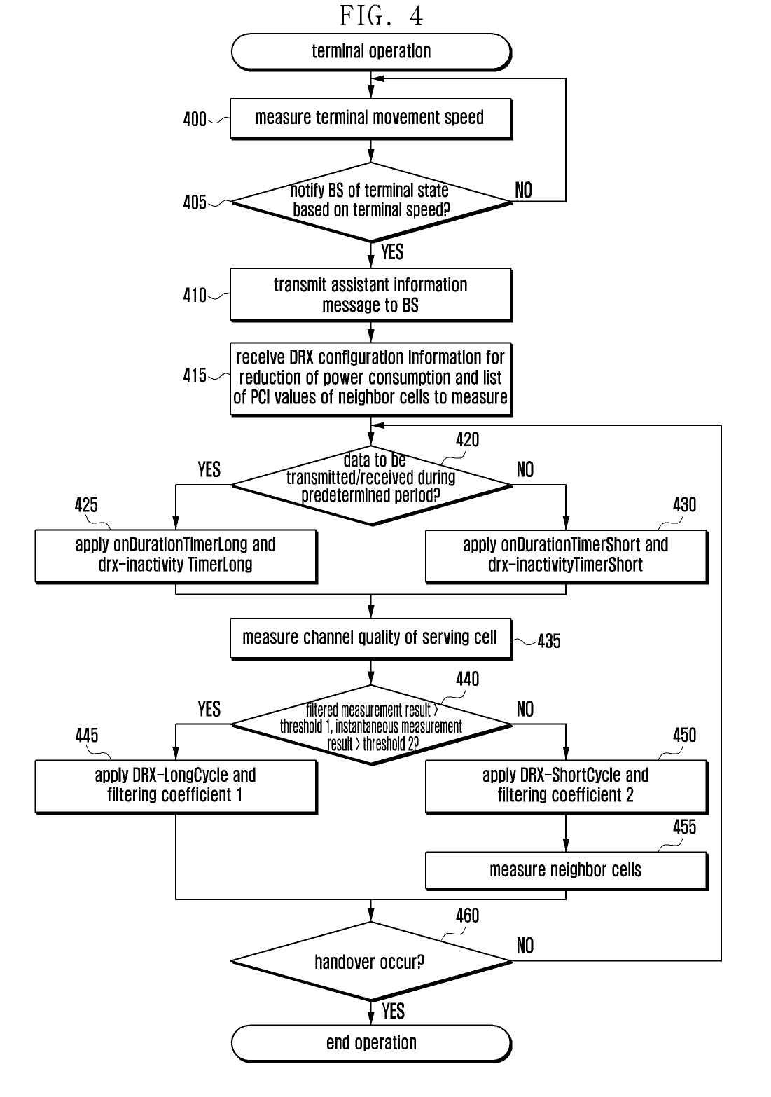

The above information is characterized in that a plurality of on DurationTimers and DRX-inactivityTimers are provided. For example, the on DurationTimerLong is longer than on DurationTimerShort. The terminal performs dynamic DRX operation at operation 315. The terminal performs the DRX operation dynamically by applying distinct control information provided by the base station depending on specific conditions. The specific conditions are described with reference to FIG. 4.

FIG. 4 is a flowchart illustrating the operation procedure of the terminal according to the first embodiment.

The terminal measures the terminal speed at operation 400. The terminal speed may be measured using GPS module of the terminal or serving cell channel quality change speed.

The terminal determines whether it is necessary to report terminal speed-related information to the base station. For example, if the terminal speed changes to be out of or in a predetermined range, the terminal sends the base station the related information at operation 410. The related information may be provided in various formats such as information indicating the terminal speed directly, information indicating whether the terminal speed has changed to be out of or in the predetermined range, information indicating whether ‘aggressive DRX configuration’ is appropriate or inappropriate, and appropriate DRX cycle length in consideration of the current terminal speed.

The base station determines the DRX configuration to be configured to the terminal in consideration of the information provided by the terminal and the terminal traffic condition and sends the terminal the DRX configuration information. The terminal receives the DRX configuration information transmitted by the base station. At this time, the neighbor cell measurement information may be transmission together.

Afterward, the terminal performs DRX operation using the DRX configuration information. That is, the terminal determined DRX cycle, on DurationTimer, drx-inactivityTimer, etc. to be applied. In more detail, the terminal determines whether new data transmission occurs during a predetermined period at operation 420. If there is no data transmission, the terminal applies on DurationTimerLong, drx-inactivityTimerLong, and drx-LongCycle at operation 425. That is, if there is no data transmission during relatively long period, the terminal applies a relatively long cycle and relatively short on DurationTimer and drx-inactivityTimer. For reference, on DurationTimerLong, drx-inactivityTimerLong, and drx-LongCycle are applied when there is no data transmission/reception; and on DurationTimerShort, drx-inactivityTimerShort, drx-ShortCycle are applied when data transmission/reception occurs frequently.

The on DurationTimerLong and drx-inactivityTimerLong are shorter than on DurationTimerShort and drx-inactivityTimerShort respectively, and drx-LongCycle is longer than drx-ShortCycle. If there is data transmission/reception for a predetermined duration, on DurationTimerShort, drx-inactivityTimerShort, and drx-ShortCycle are applied. In more detail, if new data transmission/reception occurs, the terminal starts or restarts the drx-inactivityTimer (drx-inactivityTimerShort or drx-inactivityTimerLong).

If the drx-inactivityTimer (drx-inactivityTimerShort or drx-inactivityTimerLong) expires and if the drx-ShortCycleTimer is not running, the terminal starts the drx-ShortCycleTimer. The on DurationTimerShort, drx-inactivityTimerShort, and drx-ShortCycle are applied before the expiry of the drxShortCycleTimer and then, if the drxShortCycleTimer expires, the on DurationTimerLong, drx-inactivityTimerLong, and drx-LongCycle.

In the state of performing DRX operation in accordance with data transmission/reception condition, the terminal measures channel qualities of the serving and neighbor cells and operates according to the measurement result. In more detail, the terminal measures the channel quality of the serving cell at operation 435. At operation 440, the terminal determines whether the L3 filtered measurement result is equal to or greater than the first threshold value and the instantaneous measurement result is equal to or greater than the second threshold value. The first and second threshold values may be provided by the base station or predetermined. The L3 filtering is a procedure of filtering the measurement result value using the following equation.

Fₙ=(1−a)·Fₙ₊₁+a·M (1)

Here, Fₙ₋₁ denotes the old filtering value, Mₙ (i.e. Instantaneous measurement result) denotes the newly measured result value. At this time, the new filtering value Fₙ (i.e. filtered measurement result) is derived by applying coefficient a. Such a filtering method is applied in general to derive the measurement information value in LTE technology.

If both the two result values are equal to or greater than the first and second threshold values respectively, the terminal assesses the measurement result of the serving cell by applying the first filtering coefficient value at operation 445. If at least one of the two result values is less than the corresponding threshold value, the terminal assesses the measurement result by applying the second filtering coefficient value at operation 450.

If the current DRX cycle is drx-LongCycle, the terminal switches the DRX cycle to drx-ShortCycle. Instead of switching the DRX cycle, the terminal may perform measurement at every drx-ShortCycle other than drx-LongCycle.

At operation 455, the base station measures channel quality for neighbor cells in the PCI list provided by the base station. The reason for determining the DRX cycle based on the channel quality of the serving cell is associated with handover. Since the handover probability increases when the channel quality of the serving cell becomes equal to or less than a predetermined value, the UE starts measuring channel quality of neighbor cells. This is to avoid unnecessary neighbor cell measurement. Since the terminal performs measurement in the active period of the DRX cycle, long DRX cycle increases the measurement period so as to be likely to miss out the handover timing.

In the present embodiment, when the channel quality of the serving cell drops, the UE applies the short DRX cycle to perform the neighbor cell measurement. The terminal determines whether the handover is performed at operation 460. If handover is not performed, the terminal performs appropriate DRX operation according to the above-described procedure.

### Second Embodiment

The second embodiment proposes a method of acquiring channel status information promptly in resuming transmission/reception. The terminal reports Channel Quality Indicator (CQI) under the control of the base station. The reported CQI is used for the base station to determine the data rate of the terminal. The CQI report is performed in a periodic report mode or aperiodic report mode or in both the periodic and aperiodic report modes. In the case of operating in both the two report modes, if both the periodic and aperiodic CQI reports are scheduled in the same subframe, it is enough to perform only the aperiodic CQI report. If the terminal is allocated PUSCH resource in the subframe corresponding to the periodic CQI report timing, the UE reports the periodic CQI on the PUSCH and, otherwise, on the PDCCH. The aperiodic CQI report is scheduled by the base station using PDCCH and performed using PUSCH.

In the second embodiment, a method for acquiring channel status information promptly especially when resuming data transmission/reception for the terminal after long absence of data transmission/reception. In more detail, if no data transmission/reception occurs for predetermined time duration, the terminal releases the periodic CQI resource autonomously while maintaining the aperiodic CQI configuration. If the data transmission/reception is resumed afterward, the terminal performs aperiodic CQI report by applying the aperiodic CQI configuration.

In this way, it is possible to reduce unnecessary signaling in advance and report channel status promptly, resulting in reduction of unnecessary transmission power consumption. For CQI report, the base station has to provide the terminal with CAI configuration (CQI configuration) information. The CQI configuration is released when the TA timer (TimeAlighmentTimer) expires. The base station sends the terminal a Time Advance (TA) command for synchronization of the terminal.

If the TA command is received, the terminal starts a TA timer. The terminal assumes that the terminal synchronization is acquired until the TA timer expires. In order for the terminal to transmit data after the expiry of the TA timer, the terminal performs random access to receive the TA command again in the Random Access Response (RAR) message. The TA command is transmitted to the terminal using MAC CE as well as RAR.

Since the terminal releases the CQI configuration on the expiry of the TA timer, it has to receive CQI configuration again from the base station in order to report CQI again. Accordingly, the base station is capable of receiving the channel status information of the terminal resuming data transmission quickly. In this embodiment, in order to receive the channel quality information promptly in resuming data transmission after expiry of the TA timer, the UE maintains the aperiodic CQI report configuration even after the TA timer has expired to report CQI.

In this embodiment, the terminal operation is divided into two steps. The first step is of being performed when the TA timer has expired, and the second step is of being performed when new data transmission/reception is resumed after long absence of data transmission/reception.

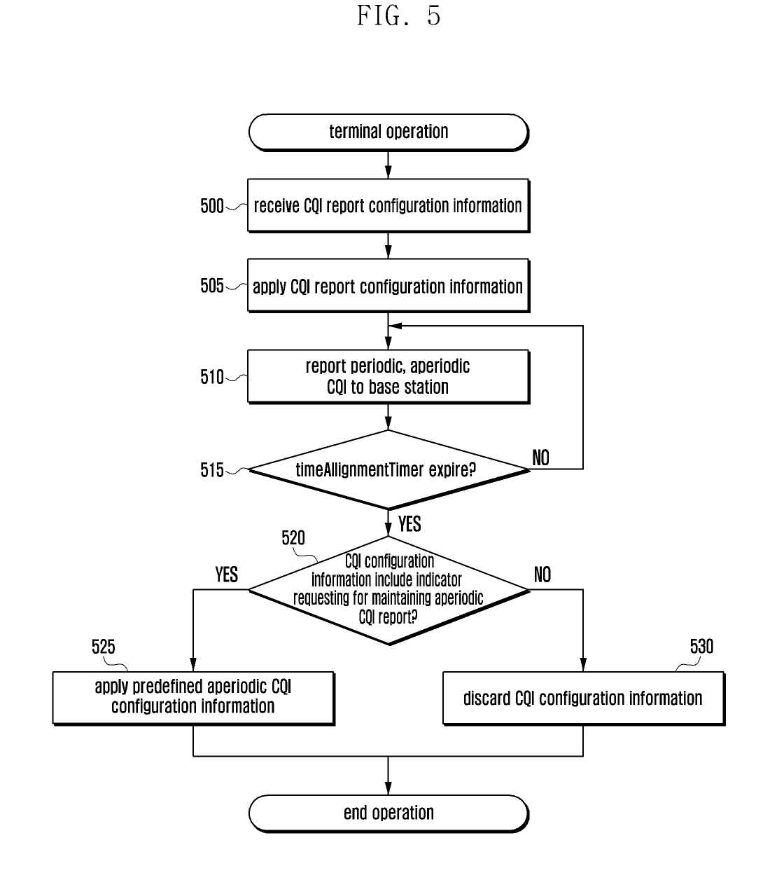

FIG. 5 is a flowchart illustrating the terminal operation when the TA timer expires. The terminal receives control information related to the CSI report from the base station at operation 500. The control information may include periodic CQI report configuration, aperiodic CQI report configuration, and an indicator commanding to maintain the aperiodic CQI configuration after expiry of TA timer (hereinafter, referred to as first indicator).

The periodic CQI report configuration includes the scheduling information for transmitting CQI information periodically. That is, it includes the CQI report interval and offset value. In order to derive CQI, it also includes the frequency band type for measurement. The wideband type is of performing measurement on the entire frequency band of the serving cell to derive CQI, and the subband type is of performing a part of the frequency band of the serving cell to derive CQI.

The aperiodic CQI report configuration includes aperiodic CSI trigger information. This indicates a cell for aperiodic CQI report among a plurality serving cells when the carrier aggregation is applied. It also includes the reporting mode information. The reporting mode indicates wideband/subband type and whether to transmit PMI. The first indicator may be included or not, and the terminal may operate differently depending on whether the first indicator is included. The base station may include the first indicator for the terminal fulfilling the following condition.
The terminal for which small size data occurs sporadically at a relatively long interval.

This is because it is preferred to receive aperiodic CQI quickly from the terminal characterized by the above property when new data occurs after long absence of data transmission.

The terminal applies the periodic and aperiodic CQI report configurations at operation 505. The terminal performs CQI report at operation 510. As described above, the CQI report can be performed in the periodic or aperiodic mode or in both the periodic and aperiodic modes. In the case of operating in both the periodic and aperiodic modes, if the periodic and aperiodic CQI reports have to be performed in the same subframe, it is enough to perform only the aperiodic CQI report. The subframe carrying the periodic CQI is determined depending on the interval and offset information included in the periodic CQI report configuration received at operation 505. The terminal is allocated PUSCH resource at the subframe corresponding to the periodic CQI report timing, the terminal reports CQI periodically on PUSCH and, otherwise, on PUCCH. For example, if the scheduling information for aperiodic CQI is received on PDCCH of n^{th} subframe, the terminal reports the aperiodic CQI information to the base station at the (n+k)^{th} subframe. The value of k is specified in TS36.213 as shown in table 1.

TABLE 1

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

The terminal determines whether the TA timer has expired at operation 515. If the TA timer has expired, the terminal determines at operation 520 whether it is released after the first indicator and, if so, releases the current aperiodic CQI configuration and periodic configuration and apply a predetermined second aperiodic CQI configuration. Also, it is possible to release only the periodic CQI configuration while maintaining the current aperiodic CQI configuration. Here, the second aperiodic CQI report configuration is of being agreed between the terminal and the base station. For example, the aperiodic CQI may be triggered in the PCell, among the serving cells, and applied for wideband type. If the second indicator has never been received or of received but released already, the terminal releases both the periodic and aperiodic CQI report configurations at operation 530. Afterward, when new data transmission/reception of the terminal starts after long absence of data transmission/reception, the base station sets the CQI-request field of the RAR message to 1 for the UE maintaining the aperiodic CQI configuration to receive the aperiodic CQI immediately. If the aperiodic CQI configuration is not maintained, the terminal does not report any aperiodic CQI in spite of the receipt of the control information including the CQI-request set to 1.

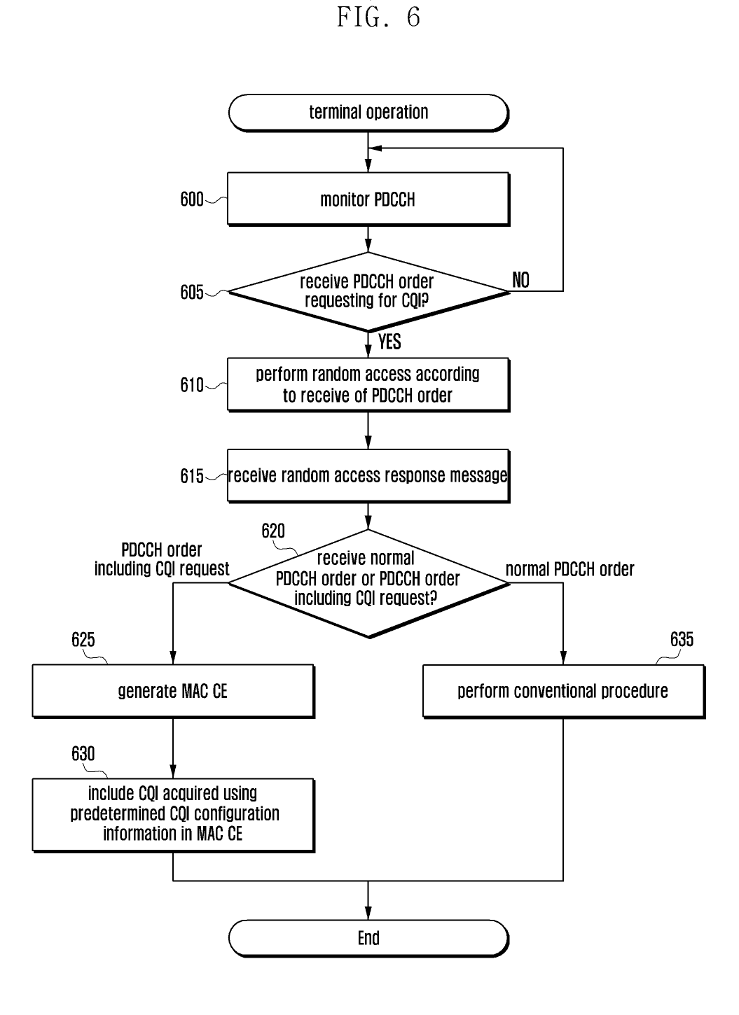

FIG. 6 is a flowchart illustrating another terminal operation when new data transmission/reception starts after long absence of data transmission/reception.

In FIG. 6, the terminal reports a MAC CE containing the CQI information according to the command of the base station in the random access procedure. The base station sets a predetermined field of PDCCH order to a predetermined value to instruct to the terminal to include a CQI MAC CE in performing uplink transmission according to the uplink grant of the RAR message when it performs random access.

The terminal monitors PDCCH at operation 600. This is to check the scheduling information addressed to the terminal. The terminal determines whether PDCCH order is received from the base station at operation 605. The PDCCH order is a kind of control information transmitted on PDCCH to instruct the terminal to perform random access.

The PDCCH order has the same format as the conventional uplink grant control information and can be distinguished from the uplink grant control information by setting a predetermined field to a predetermined value. In the present disclosure, PDCCH order 2 is defined to instruct the terminal to reports CQI MAC CE after completing random access by setting the predetermined filed to a value different from that of the PDCCH order. If the PDCCH order is received, the terminal performs random access at operation 610. That is, the terminal transmits the random access preamble using the resource predetermined in predetermined time duration. The terminal receives the RAR message at operation 615. The RAR message includes TA command, uplink grant, etc. The terminal adjusts the uplink transmission timing by applying the received TA command and starts the TA timer. The terminal determines whether the signal received at operation 605 is the PDCCH order or the PDCCH order 2 at operation 620. If the PDCCH order has been received, the terminal generates and transmits MAC PDU as scheduled by the uplink grant according to the convention technology at operation 635.

Otherwise if the PDCCH order 2 has been received, the terminal generates a CQI MAC CE at operation 625. The CQI MAC CE may include the information on the channel quality of the current serving cell which has been measured by the terminal, e.g. the channel quality information of the Cell Reference Signal (CRS) on a predetermined part of the entire bandwidth of the serving cell. The terminal generates the MAC PDU including the CQI MAC CE and transmits the MAC PDU as scheduled by uplink grant.

### Third Embodiment

The third embodiment proposes a method of releasing the RRC connection when a mobility problem occurs to the terminal operating in the RRC connected state for long time without data transmission/reception.

In smartphone environment, the terminal may stay in the RRC connected state for long time without any data transmission/reception. Typically, such a terminal is configured with long DRX cycle which is likely to cause handover failure. If the handover failure occurs to terminal operating in the RRC connected state for long time without any data transmission/reception and if the terminal continues staying in the RRC connected state, the handover failure may occur again. For such a terminal, it is preferred to release the RRC connection rather than recover the RRC connection to reduce signaling overhead.

An embodiment of the present disclosure proposes a method of performing RRC release after RLF occurrence in the above situation under the control of the base station. The third embodiment of the present disclosure is summarized in such a way that, if handover failure (Radio Link Failure RLF)) occurs due to the terminal characteristic or terminal traffic condition, the base station instruct to release RRC connection rather than reconfigure the RRC connection in a new cell. If a new cell accessible is found after the RLF, the terminal initiates the RRC connection release procedure rather than the normal RRC connection reestablishment.

In order to perform the RRC connection release procedure, the terminal provides the base station with the information on the old base station, and the new base station exchanges necessary information with the old base station to perform authentication of the RRC connection release request of the terminal. An embodiment of the present disclosure proposes a method for the terminal to notify the base station of the request for the RRC connection release other than RRC connection reestablishment by setting a reserved field of the legacy RRC connection reestablishment message to an appropriate value.

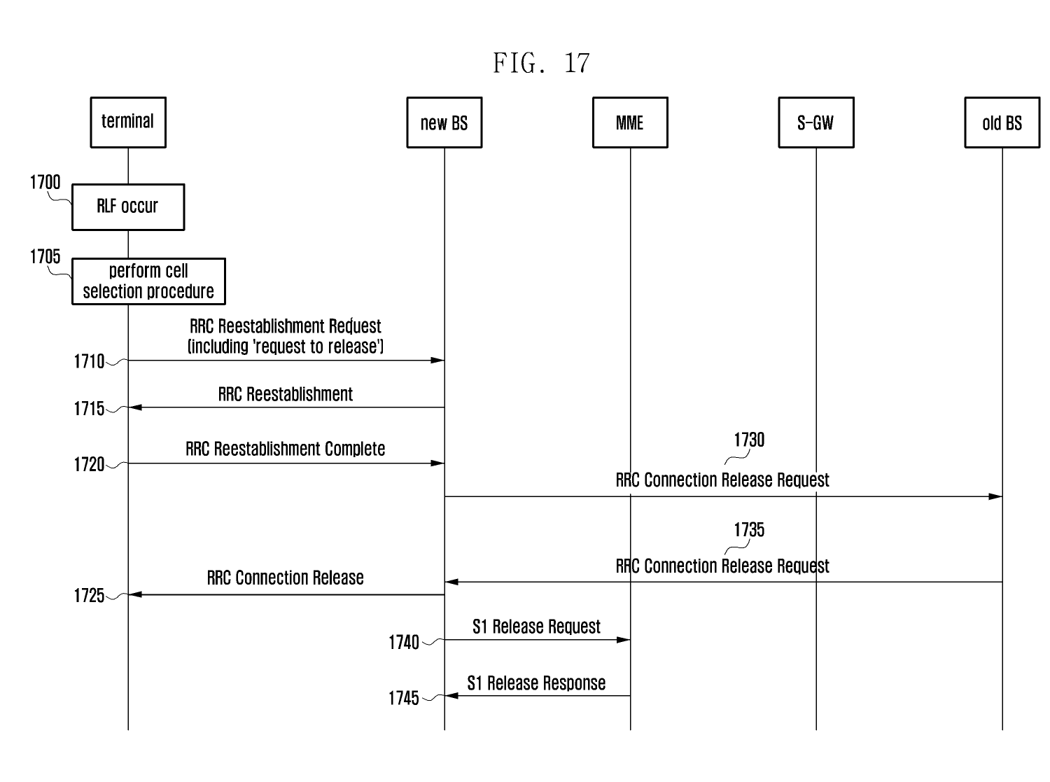

FIG. 17 is a signal flow diagram illustrating entire operation between a base station and a terminal according to the third embodiment.

The terminal undergoes RLF at operation 1700. The terminal searches for suitable cell at operation 1705 and attempts RRC connection reestablishment procedure. At operation 1710, the terminal sends the base station an RRC Reestablishment Request message as the first operation of the RRC Reestablishment procedure. According to an embodiment of the present disclosure, the RRC message includes an indicator of instructing to release the RRC connection instead of reconfiguring RRC connection in a new cell. In addition, the RRC Reestablishment Request message may contain a security token, a C-RNTI value used at the old base station, and Physical Cell ID (PCI) of the old base station.

The base station sends the terminal an RRC Reestablishment message for SRB1 configuration at operation 1715. The terminal sends the base station an RRC Reestablishment Complete message at operation 1720 and configures SRB1.

The base station sends the old base station an RRC Connection Release Request for the terminal at operation 1730. At this time, the security token, and C-RNTI value used at the old base station are transmitted together such that the old base station identifies the terminal.

The old base station sends the new base station an RRC Connection Release message at operation 1735. The base station sends the terminal the RRC Connection Release message at operation 1725, and the terminal releases the connection.

The base station sends the MME an S1 Release Request message at operation 1740 to notify of the connection release of the terminal. The MME sends a S1 Release Response message in reply at operation 1745.

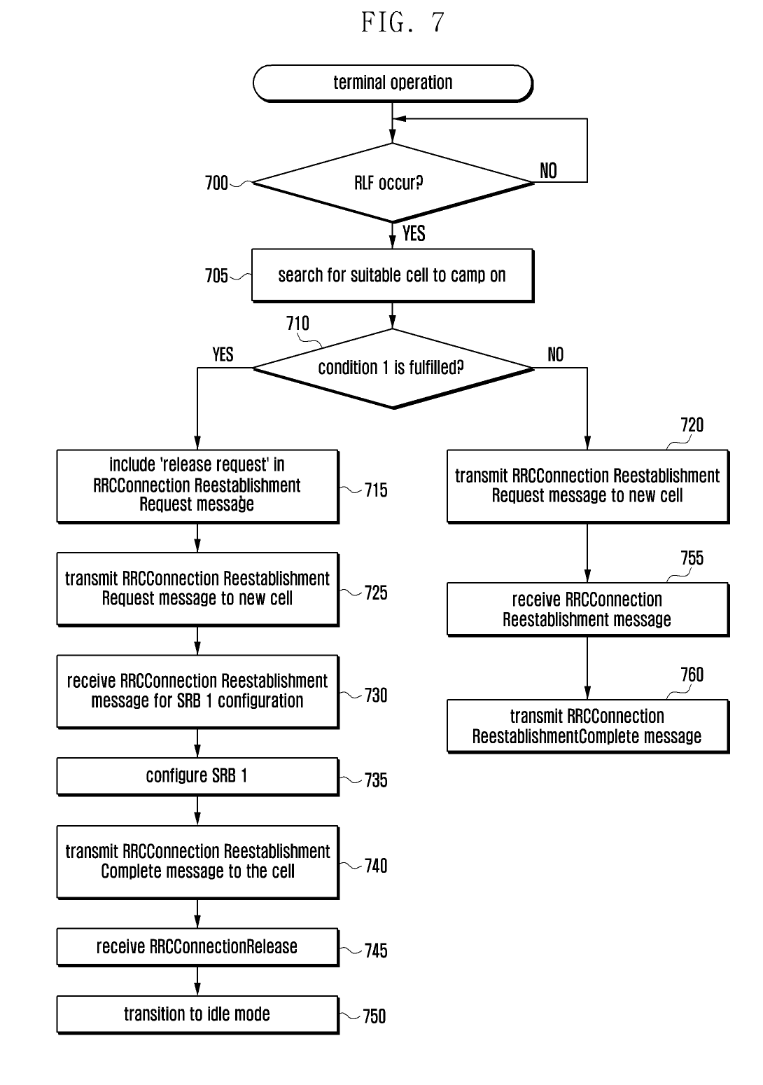

FIG. 7 shows another operation of the terminal.

The terminal determines whether RLF occurs at operation 700. If RLF occurs, the terminal initiates cell selection procedure at operation 705. Through the cell selection procedure, the terminal searches for suitable cells and, if a suitable cell is found, initiates a predetermined RRC procedure with the cell. The terminal determines a type of RRC procedure to be performed at operation 710.

At operation 710, the terminal determined whether condition 1 is fulfilled and, if it is fulfilled, the procedure goes to at operation 715 and, otherwise, at operation 720.

[Condition 1]

The ‘indicator 2’ is received in the serving cell where the RLF has occurred (or serving cell when the RLF has occurred; hereinafter referred to as old serving cell) and the connection is not released; or

The terminal has not transmitted/received data for a predetermined duration, and the DRX cycle applied at the time when the RLF has occurred is longer than a predetermined threshold.

The terminal initiates RRC connection release procedure at operation 715.

The RRC connection release procedure is performed as follows.

The terminal generates a predetermined RRC control message including the following information at operation 715 and sends the base station the RRC control message request for RRC connection release at operation 725.
Security Token: LSB 16 bits of MAC-I calculated for VarShortMAC-Input (see 36.331 section 8). The following information is used to calculate the MAC-I information. Security key of the terminal which has been used in the old cell, information on the old cell (e.g. cell identifier), predetermined COUNT, etc.
cell identifier of terminal which has been used in old serving cell (C-RNTI)
RRC connection release request indicator

The terminal waits until SRB 1 is configured after transmitting the control message to the base station. The terminal receives an RRC Connection Reestablishment message from the base station at operation 730. If the SRB 1 is configured at operation 735, the terminal generates a predetermined RRC control message, e.g. RRC CONNECTION REESTABLISHMENT COMPLETE message, based on the configured SRB 1 and transmits the message at operation 740. The control message includes the following information.
identifier of old cell: information for identifying the old base station in order for the current base station to transmit the security token and release request information to the old base station. Accordingly, the old cell identifier information should be a unique identifier in the corresponding area at least (or corresponding operator network).

Afterward, the terminal receives the RRC Connection Release message from the base station at operation 745 and releases its RRC connection at operation 750.

The terminal initiates RRC connection reestablishment procedure at operation 720.

The RRC connection reestablishment procedure is performed as follows.

The terminal sends the base station of a predetermined RRC control message requesting for RRC connection reestablishment at operation 725. The control message includes following informations.
Security Token: LSB 16 bits of MAC-I calculated for VarShortMAC-Input (see 36.331 section 8). The following information is used to calculate the MAC-I information. Security key of the terminal which has been used in the old cell, information on the old cell (e.g. cell identifier), predetermined COUNT, etc.
cell identifier of terminal which has been used in old serving cell (C-RNTI)
RRC connection reestablishment reason information: indicate whether the connection reestablishment is caused by handover failure or other reason

The terminal sends the base station the control message and takes an operation necessary according to the RRC control message transmitted by the base station. The base station performs authentication to the security token transmitted by the terminal and, if the authentication is successful, continues the RRC connection reestablishment procedure.

The terminal receives an RRC Connection Reestablishment message from the base station at operation 755. The terminal sends the base station the RRC Connection Reestablishment Complete message at operation 760 and completes the RRC reestablishment procedure successfully. If the authentication fails, the terminal determines that the RRC reestablishment has failed and thus sends the terminal the RRC Connection Reestablishment failure message. If the RRC Connection Reestablishment Failure message is received, the terminal initiates RRC Connection Establishment procedure.

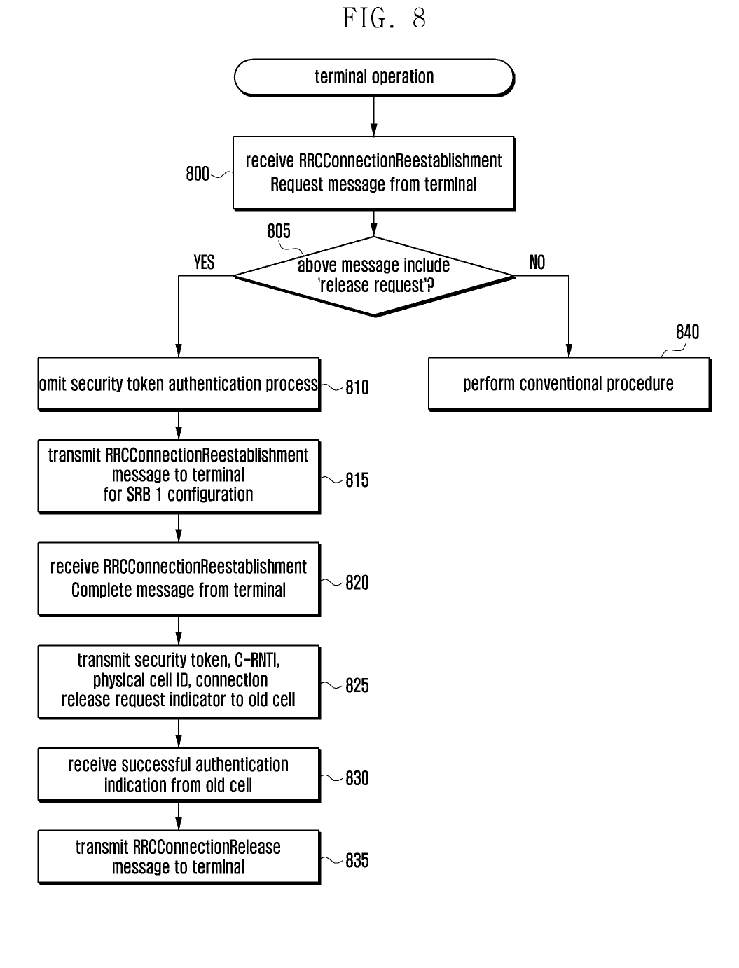

FIG. 8 is a flowchart illustrating the operation procedure of the base station according to the third embodiment.

The base station receives an RRC Connection Reestablishment Request (RRCConnectionReestablishmentRequest) message from the terminal at operation 800. The base station determines whether the message includes a ‘release request’ at operation 805.

If the message includes the release request, the base station skips the at operation of verifying security token at operation 810 and sends the terminal an RRC Connection Reestablishment (RRCConnectionReestablishment) message for configuring SRB 1 at operation 815.

The base station receives an RRC Connection Reestablishment Complete (RRCConnectionReestablishmentComplete) message including global cell id information of the old cell from the terminal at operation 820. The base station sends the base station of the old cell the security token, C-RNTI, PCI, and release request using the global cell id information of the old cell which has been provided by the terminal at operation 825.

The base station receives a control message notifying of the successful authentication of the security token and instructing of RRC connection release from the base station of the old cell at operation 830. The base station sends the terminal an RRC Connection Release (RRCConnectionRelease) message at operation 835.

### Fourth Embodiment

The fourth embodiment proposes a method of suspending monitoring PDCCH until a PDCCH assignment for new transmission is received after the transmission of Dedicated Scheduling Request (D-SR). This is effective to reduce the power consumption of the terminal.

The D-SR is a signal transmitted to request the base station to allocate resource when the terminal has data to transmit. The base station allocates resource to the terminal using Buffer Status Report (BSR) information transmitted by the terminal. In a certain case, however, the terminal may not be allocated any resource for transmitting BSR information.

At this time, the terminal requests for allocating resource necessary for transmission of BSR information using the D-SR. After transmitting the D-SR, the terminal monitors PDCCH in the active state until PDCCH scheduling information is received.

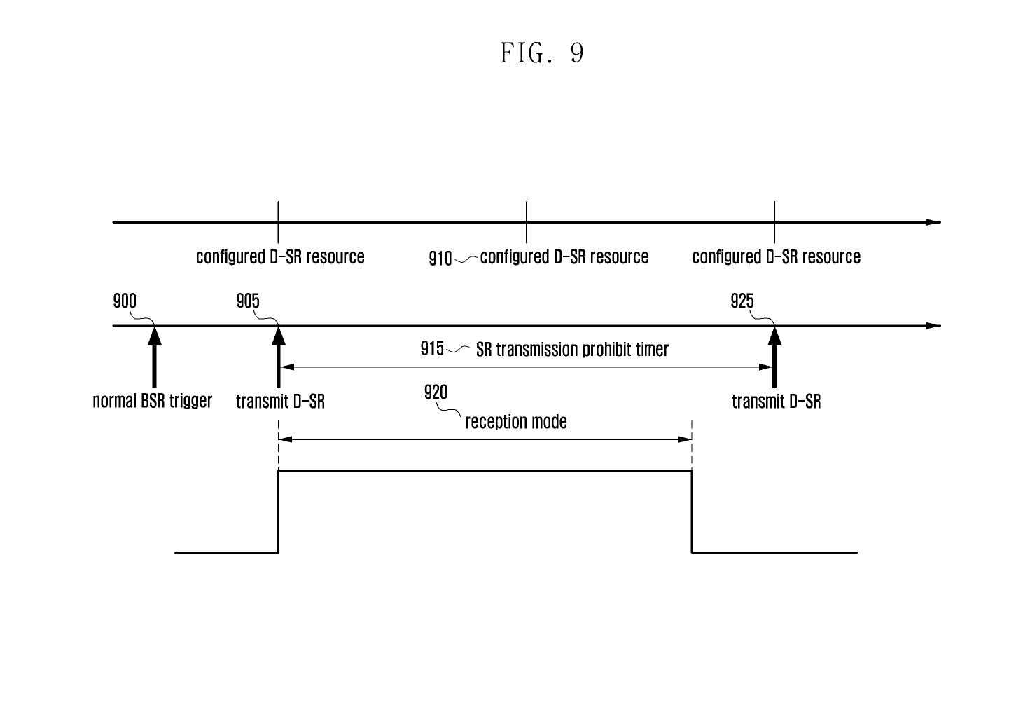

FIG. 9 is a diagram illustrating PDCCH monitoring operation after D-SR transmission.

First, regular BSR 900 is triggered.

If there is not resource for transmitting the BSR, the terminal sends the D-SR 905 using PDCCH 910. After transmitting the D-SR, the terminal starts an SR prohibit timer 915 and transmits the D-SR again while the timer is running. If it fails to acquire scheduling information on PDCCH, the terminal transmits the D-SR again after the expiry of the SR prohibit timer.

In order to monitor PDCCH, the terminal maintains the active time 920. At this time, the terminal consumes power in during the active time.

Since there is Round Trip Time (RTT) on the real radio link, it is impossible to receive scheduling information right after the D-SR transmission. Accordingly, it just causes unnecessary power consumption of the terminal to maintain monitoring PDCCH after transmitting the D-SR as in the conventional technology. The present disclosure proposes a method for reducing power consumption of the terminal by triggering PDCCH monitoring in consideration of RTT.

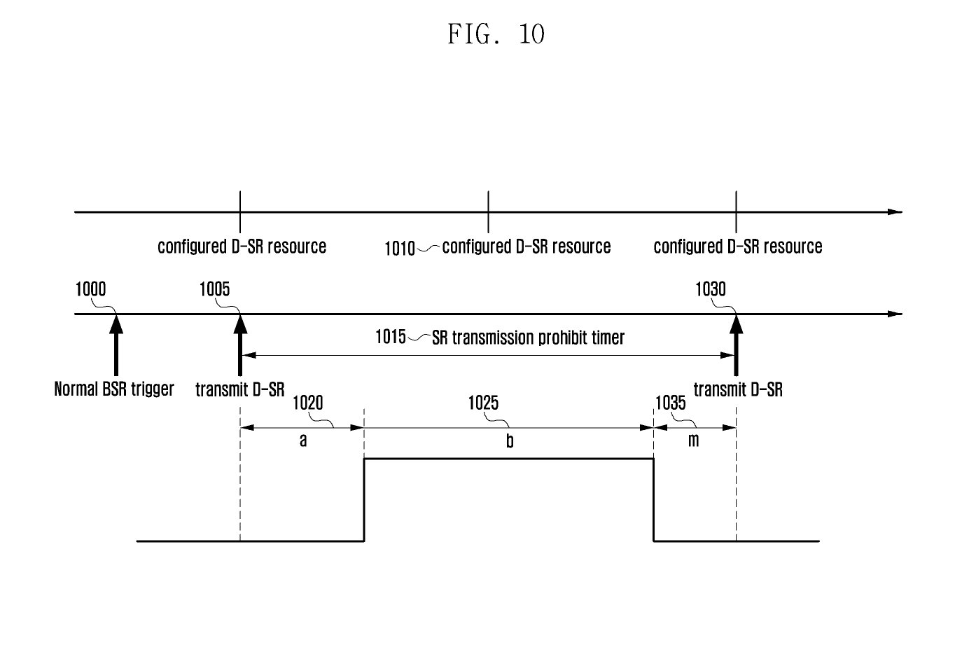

FIG. 10 is a diagram illustrating the concept of the disclosure according to the fourth embodiment.

First, the Regular BSR 1000 is triggered. If there is no resource for transmitting BSR, the terminal transmits the D-SR using PUCCH 1010. After transmitting the D-SR, the terminal starts the SR prohibit timer 1015 and the D-SR cannot be transmitted again before the expiry of the timer. If no scheduling information is acquired from PDCCH, the terminal retransmits the D-SR after expiry of the SR prohibit timer. In order to monitor PDCCH, after time ‘a’ 1020 elapses since the D-SR transmission, the terminal enters the active time b 1025. During the time a, the terminal is capable of conserving power. After predetermined active time or at a time earlier as much as time m 1035 than the next D-SR transmission occasion, the terminal transitions back to the non-active time.

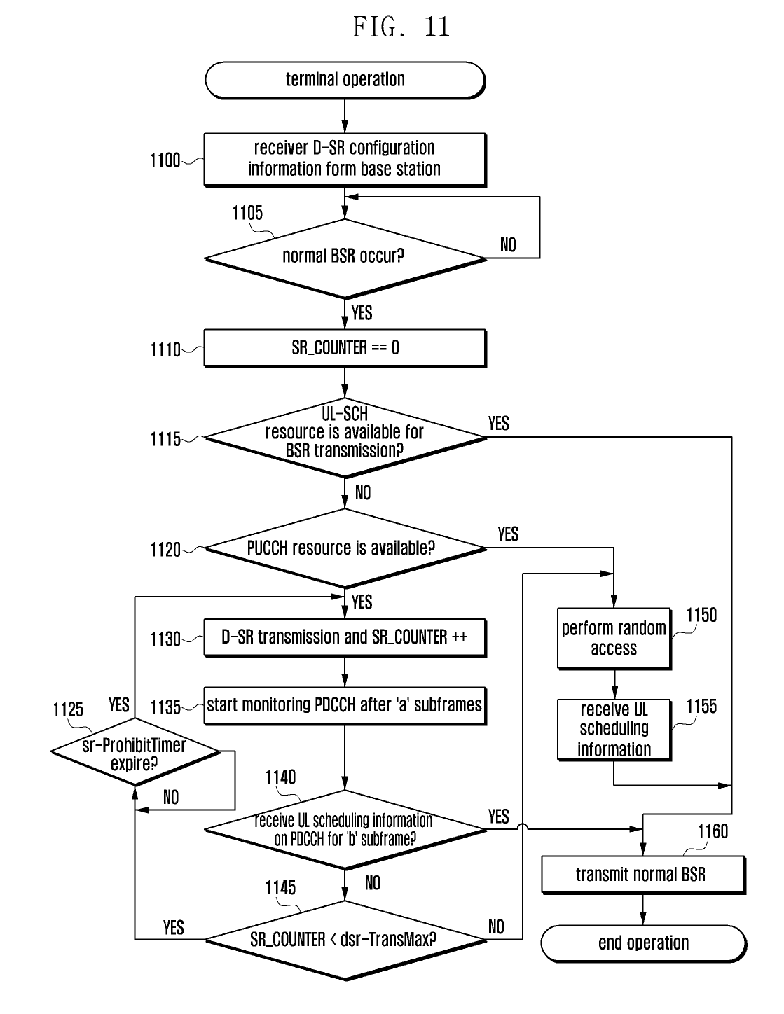

FIG. 11 is a flowchart illustrating the operation procedure of the terminal according to the fourth embodiment.

First, the terminal receives D-SR control information at operation 1100. The control information includes conventional D-SR configuration, SR prohibit timer, a, and b. At this time, the unit of ‘a’ and ‘b’ is subframe.

The terminal determines whether regular BSR occurs at operation 1105. If the regular BSR occurs, the terminal sets SR_COUNTER to 0 at operation 1110.

The terminal determines whether there is UL-SCH resource for transmitting BSR at operation 1115. If so, the terminal transmits BSR at operation 1160. Otherwise, the terminal determines whether there is PUCCH resource. If there is no PUCCH resource, the terminal performs random access at operation 1150 and acquires uplink resource allocation information (UL grant) from the RAR message transmitted by the base station at operation 1155. The terminal transmits BSR based on the UL grant at operation 1160. If there is valid PUCCH resource, the terminal transmits the D-SR and increments the SR_COUNTER by 1 at operation 1130. The terminal monitors PDCCH after ‘a’ subframes at operation 1135.

The terminal determines whether a UL grant is received during ‘b’ subframes at operation 1140. If received, the terminal transmits the BSR based on the UL grant at operation 1160. Otherwise if not received, the terminal determines whether the SR_COUNTER value is greater than the first threshold value (dsr-TransMax) at operation 1145. If not greater than the first threshold value, the terminal determines whether the SR prohibit timer has expired at operation 1125 and, if so, retransmits the D-SR.

### Fifth Embodiment

The fifth embodiment proposes a method of preventing frequent handover failure between macro and pico cells. In the conventional technology, handover is performed through a plurality of signal exchanges which may causes handover failure. Particularly, the handover between macro and pico cells occurring frequently due to the small service area of the pico cell has a high probability of failure.

This embodiment proposes a method of providing the configuration information of the target cell to facilitate fast handover. In more detail, the present disclosure proposes a method and apparatus for resuming communication immediately when a terminal moves to a cell of a base station through exchanging control signals between the macro or pico base station and the overlaid pico or macro base station before the initiation of the handover of the terminal.

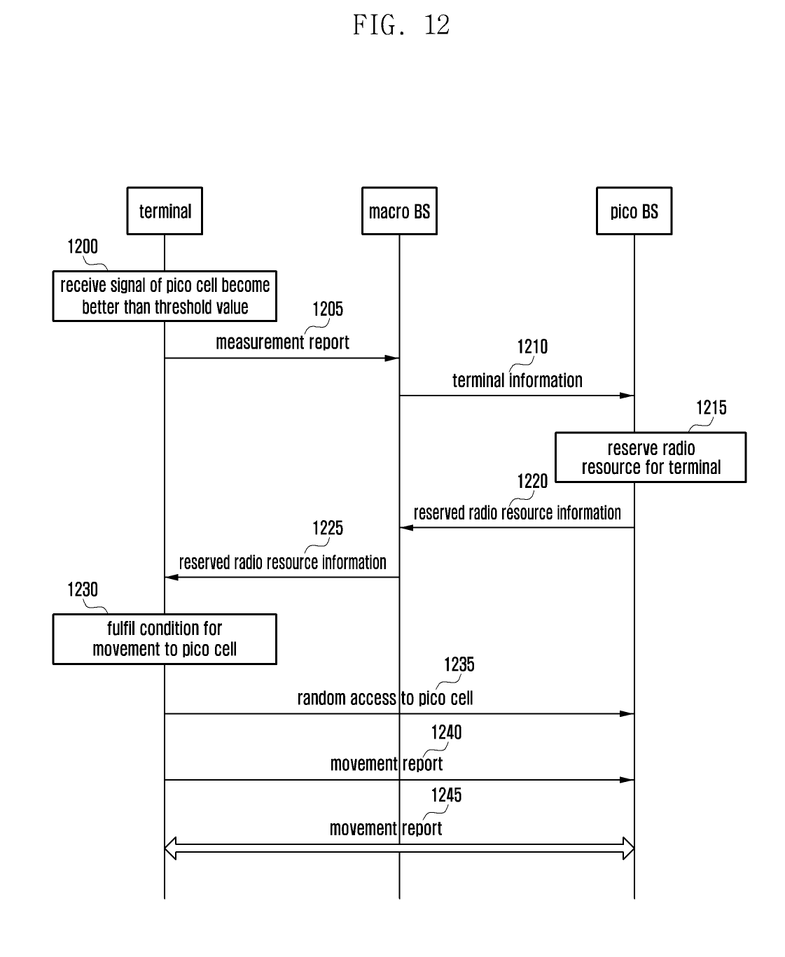

FIG. 12 is a signal flow diagram illustrating signal flows among the terminal and macro and pico cells according to the fifth embodiment.

The terminal measures channel quality of the pico cell near around at operation 1200. If the channel quality of the pico cell is equal to or greater than a predetermined threshold, the terminal reports this to the base station at operation 1205. The macro cell base station sends the pico cell base station the terminal information at operation 1210. The pico cell base station reserves radio resource for the terminal at operation 1215. The reserved resource does not allocated to other terminal during a predetermined period. The pico cell base station sends the macro cell base station the reserved resource information at operation 1220. The macro cell base station sends the terminal the reserved resource information at operation 1225. The resource information is as follows.
potential target cell identifier (PCI and ARFCN)
potential target cell information (random access information)
C-RNTI to be used in potential target cell
validity period of above resources
condition for move to potential target cell (e.g. the state in which the channel state of the serving cell is equal to or less than a predetermined threshold and the channel state of the potential target cell is equal to or greater than a predetermined threshold lasts for a predetermined duration)

The terminal determines whether the above-described condition to move to the pico cell is fulfilled at operation 1230. If the condition is fulfilled, the terminal attempts random access to the pico cell at operation 1235. If the random access succeeds, the terminal transmits a predetermined RRC control message reporting movement to the pico cell at operation 1240. The terminal performs data communication with the pico cell at operation 1245.

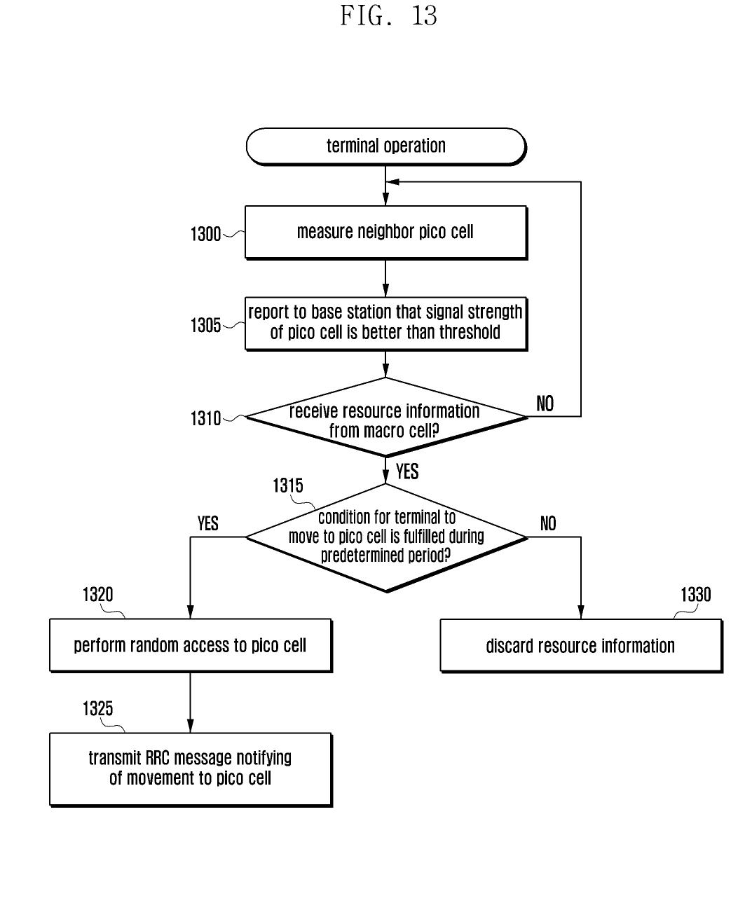

FIG. 13 is a flowchart illustrating the operation procedure of the terminal according to the fifth embodiment.

The terminal measures the pico cell near around at operation 1300. If the channel quality of the pico cell is better than a predetermined threshold, the terminal reports this to the macro cell base station.

The terminal determines whether the reserved resource information of the pico cell is received from the macro base station at operation 1310. The detailed informations included in this information have been described above. If this information is received, the terminal determines whether the condition to move to the pico cell is fulfilled. If the condition is fulfilled, the terminal performs random access at operation 1320. The terminal transmits a predetermined RRC control message reporting the move to the pico cell at operation 1325. If the validity period of the pico cell resource expires, the terminal discards the resource information at operation 1330.

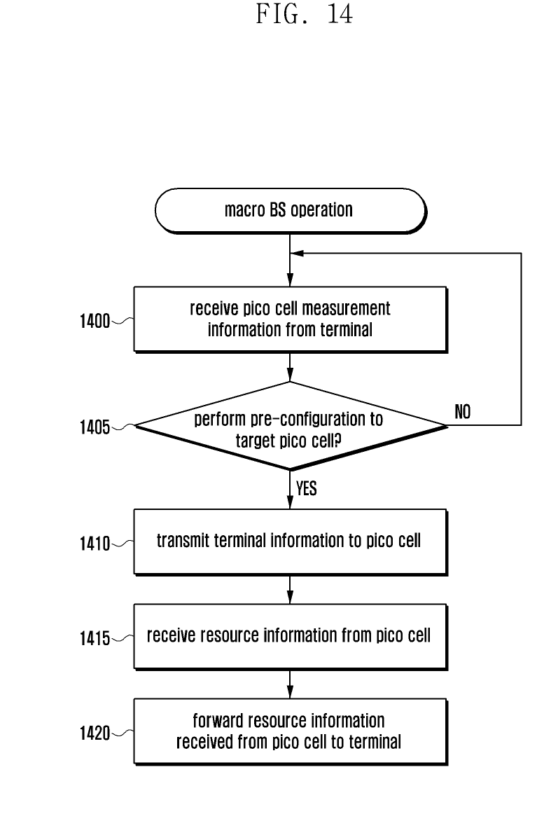

FIG. 14 is a flowchart illustrating the operation procedure of the macro cell base station according to the fifth embodiment.

The macro cell base station receives the pico cell measurement information from the terminal at operation 1400. The macro cell base station determines whether to perform pre-configuration to the pico cell at operation 1405.

If it is determined to perform pre-configuration, the macro cell base station sends the pico cell base station the information on the terminal at operation 1410. The macro cell base station receives the reserved resource information from the pico cell at operation 1415. If it fails to receive the information, this means that the pico cell has no available resource or does not support pre-configuration. The macro cell base station sends the terminal the resource information at operation 1420.

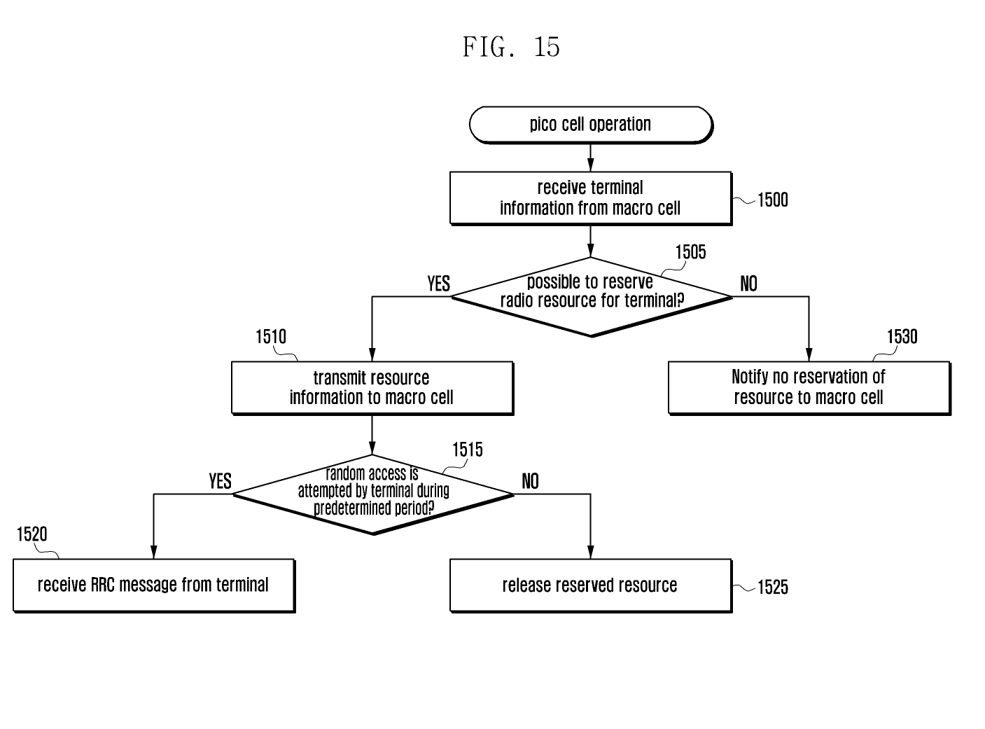

FIG. 15 is a flowchart illustrating the operation procedure of the pico cell base station according to the fifth embodiment.

The pico cell base station receives the terminal information requesting for pre-configuration from the macro cell base station at operation 1500. The pico cell base station determines whether to reserve resource for the terminal at operation 1505.

If it is determined to reserve the resource, the pico cell base station sends the macro cell base station the resource information at operation 1510. The pico cell base station determines whether random access is attempted by the terminal at operation 1515. If random access is attempted, the pico cell base station may receive a movement report message from the terminal at operation 1520. Otherwise if there is not random access attempt from the terminal during the given resource validity period, the pico cell base station releases the resource.

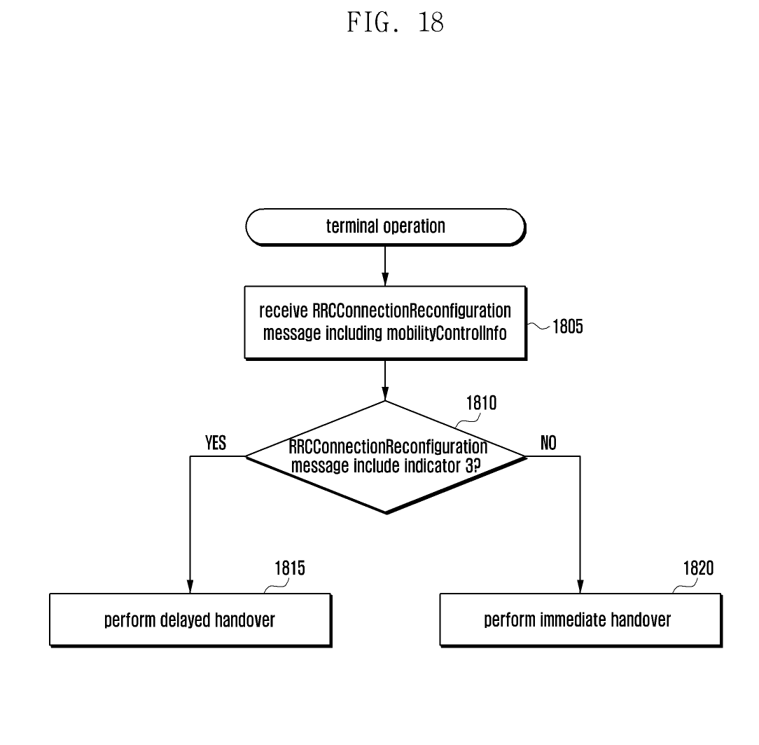

FIG. 18 is a flowchart illustrating another operation procedure of the terminal according to the fifth embodiment.

In another operation procedure, the handover is classified into one of immediate handover and delayed handover such that, in the case of the delayed handover, the terminal performs handover to the target cell when a predetermined condition is fulfilled. With the delayed handover technique, the base station may provide the terminal with the target cell information earlier. In this way, it is possible to reduce the probability of handover failure from the macro cell to the pico cell or vice versa.

The terminal receives the RRC Connection Reconfiguration (rrcConnectionReconfiguration) message including the target cell information (mobilityControlInfo) at operation 11805.

The terminal determines whether the RRC Connection Reconfiguration message includes ‘indicator 3’ at operation 1810. The indicator 3 is the control information instructing to apply the delayed handover. If the indicator 3 is not included, the terminal performs the normal handover. That is, the terminal performs handover immediately upon receipt of the handover command.

If the indicator 3 is included, the terminal performs the delayed handover at operation 1815 and transmits an RLC ACK corresponding to the RRC Connection Reconfiguration message. The delayed handover procedure is performed as follows.

First, the terminal measures the qualities of predetermined signals, e.g. CRS, of the current serving cell and a cell indicated in the mobilityControlInfo (hereinafter, candidate target cell) and compares therebetween. The terminal determines whether a predetermined event occurs during a predetermined period x1. The terminal continues normal communication procedure in the current serving cell before the event occurs. The period x1 may be indicated in the control message instructing the delayed handover procedure. The predetermined event may be that a situation where the channel quality difference between the serving cell and the candidate target cell is equal to or greater than a predetermined value lasts for predetermined duration or certain duration. At this time, the channel quality of the candidate target cell may be the channel quality to which a predetermined offset is added. Particularly if the candidate target cell is a pico cell, its transmit power is significantly lower than that of the current serving cell and thus it is inevitable to compensate the transmit power with the offset. Also, the event may be that the situation where the channel quality of the candidate target cell is equal to or greater than a predetermined threshold lasts for predetermined duration.

If the event occurs during the period x1, the terminal initiates the handover procedure to the candidate target cell. That is, the terminal acquires downlink synchronization with the candidate target cell, reconfigures the layer 2 entity, performs random access procedure, and transmits a predetermined control message, e.g. RRC Connection Reconfiguration Complete message. At this time, the terminal performs operation in the candidate target cell using the C-RNTI indicated in the mobilityControlInfo. After completing the random access procedure, the terminal re-acquires predetermined system information as soon as possible in a predetermined period. Unlike the normal handover procedure in which the system information of the target cell is provided to the terminal, it cannot be ruled out the change of the given system information in the delayed handover and thus the terminal re-acquire the system information after the handover to the target cell. In the normal handover procedure, the terminal does not re-acquire the system information after the completion of the handover as far as the base station notifies of the change of the system information.

If no event occurs during the period x1, the terminal sends the current serving cell a predetermined RRC control message, e.g. RRC Connection Reconfiguration Failure message. The control message includes control information indicating no occurrence of delayed handover and channel quality information of the candidate target cell.

If the indicator 3 is not included, the terminal performs handover procedure immediately at operation 1820 without transmitting L2 ACK message corresponding to the RRC Connection Reconfiguration message.

In this case, the terminal acquires downlink synchronization with the cell indicated in the mobilityControlInfo as soon as possible and performs random access procedure. Then the target cell transmits the RRC Connection Reconfiguration Complete message.

In order to control the handover procedure of the terminal, T304 timer is used. In the case that the immediate handover is indicated, the terminal starts the T304 upon receipt of the RRC Connection Reconfiguration message. In the case that the delayed handover is indicated, the terminal starts a t1 timer upon receipt of the RRC Connection Reconfiguration message and, if a predetermined event occurs before expiry of the t1 timer, starts the T304 at the time when the event is detected. If no even occurs, the terminal does not start the T304 timer.

If the handover completes, the terminal stops the T304. If the handover does not complete before the expiry of T304, the terminal determines it as handover failure and initiates RRC Connection Reestablishment procedure.

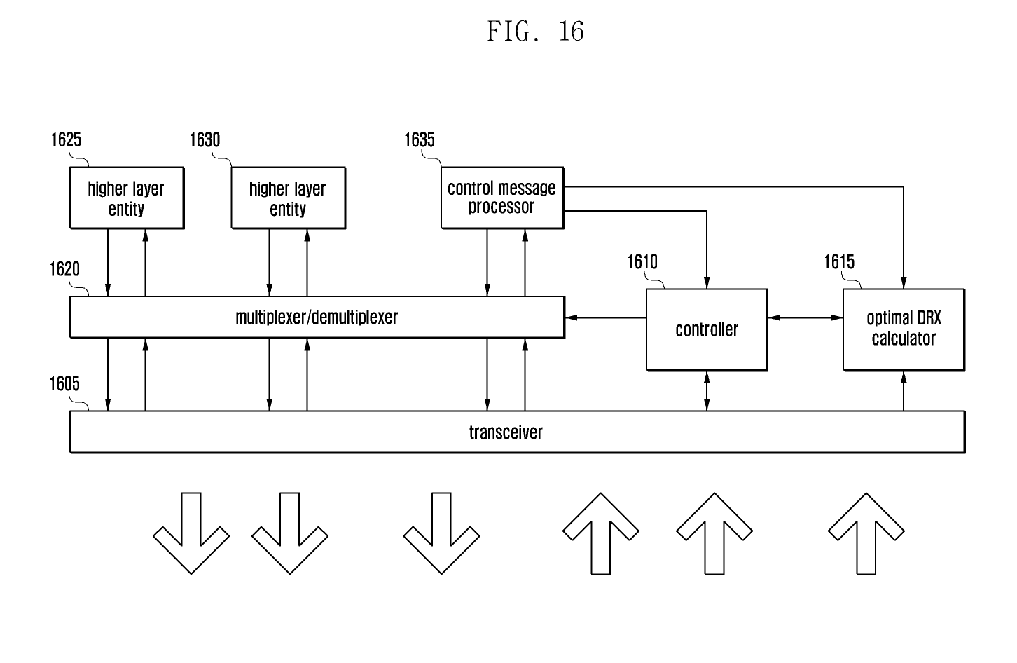

FIG. 16 is a block diagram illustrating the terminal of the present disclosure. The terminal includes a transceiver 1605, a DRX calculator 1615, a controller 1610, a multiplexer/demultiplexer 1620, a control message processor 1635, and various higher layer entities 1625 and 1630.

The transceiver receives data and predetermined control signals on the downlink carrier and transmits data and predetermined signals on the uplink carrier.

The controller controls the multiplexer/demultiplexer to generate MAC PDU according to the scheduling information in the control signal, e.g. uplink grant, received by the transceiver. The controller also determines whether to change DRX and, if necessary, controls the DRX calculator to calculate optimal DRX configuration value. Whether to change DRX id determined based on SCRI message sent by the control message processor. The controller controls the multiplexer/demultiplexer to such that the scheduling information is transmitted in match with the DRX cycle. The control unit sends the optimal DRX configuration value from the DRX calculator to the multiplexer/demultiplexer. The DRX calculator calculates optimal DRX configuration value under the control of the controller and sends the value to the controller. The DRX configuration value is processed by the control message processor so as to be transmitted to the terminal.

The multiplexer/demultiplexer multiplexes the data generated by the higher layer entities and the control message processor and demultiplexes the data received by the transceiver to deliver the demultiplexed data to appropriate higher layer entities and the control message processor.

Particularly, the controller 1610 according to an embodiment of the present disclosure measures the terminal speed-related information and sends the terminal speed-related information to the base station. The controller may control to receive the DRX configuration information from the base station in response to the terminal speed-related information and perform the DRX operation according to the received DRX configuration information.

Here, the DRX configuration information may include a plurality of on-duration timers, a plurality of DRX inactivity timers, and a plurality of DRX cycles.

The controller 1610 according to an embodiment of the present disclosure determines whether there is new data transmission/reception during a predetermined period and, if there is data transmission/reception during the period, controls to perform the DRX operation with the short cycle on-duration timer, short cycle DRX inactivity timer, and long DRX cycle. If there is no data transmission/reception during the period, the controller 1610 controls to perform the DRX operation with long cycle on-duration timer, long cycle DRX inactivity timer, and short DRX cycle.

The controller 1610 also measures the channel quality of the serving cell and, if the L3 filtered measurement result is greater than the first threshold value and the instantaneous measurement result is greater than the second threshold value, may control to perform the DRX operation with long DRX cycle. If the L3 filtered measurement result is less than the first threshold and the instantaneous measurement result is less than the second threshold, the controller 1610 also may control to perform the DRX operation with show DRX cycle.

The control message processor processes the control message transmitted by the network to take an appropriate action. For example, the control message processor may transfer PHR parameters included in the control message to the controller and provide the information on the carriers activated newly to the transceiver such that the carriers are configured to the transceiver. The higher layer device may be configured per service and process the data generated by the user service such as FTP or VoIP and transfer the processed data to the multiplexer or processes the data from the demultiplexer and deliver the data to a higher layer service application.

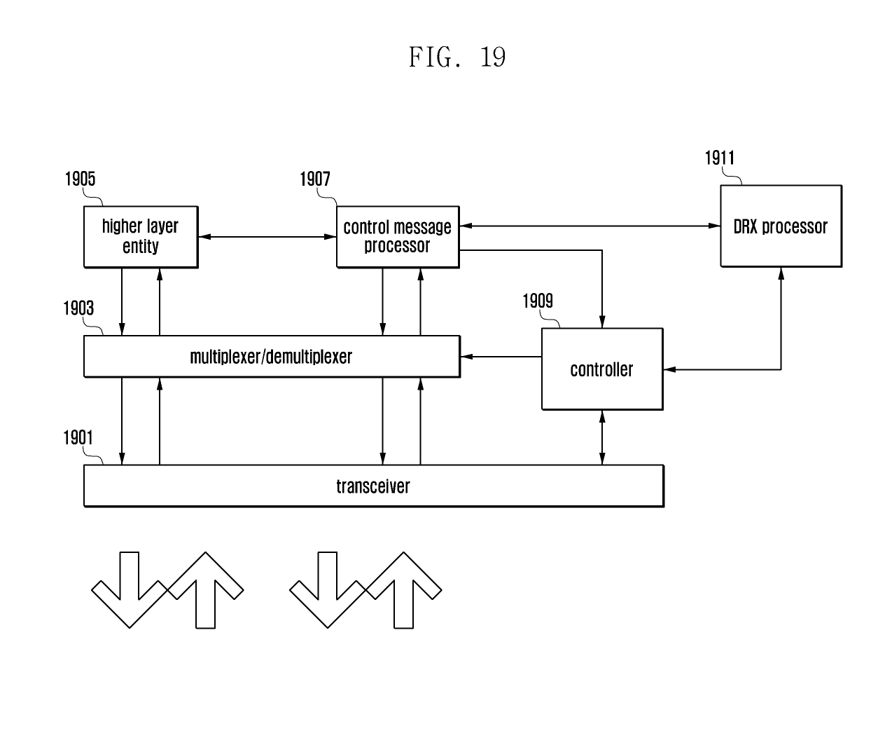

FIG. 19 is a block diagram illustrating the base station to which the present disclosure is applied.

The base station transmits/receives data associated with the higher layer entity 1905 and transmits/and receives control messages associated with the control message processor 1907 and, in transmission, multiplexes data by means of the multiplexer 1903 and transmits the multiplexed data by means of the transmitter 1901 and, in reception, demultiplexes the received signal by means of the demultiplexer 1903 and delivers the demultiplexed signals to the higher layer entity 1905 or the control message processor 1907.

The DRX processor 1911 sends the control information such as DRX information necessary in the present disclosure to the control message processor 1907. The control message processor 1907 encapsulates the information in a predetermined control message and sends the message to the multiplexer/demultiplexer 1903.

Although preferred embodiments of the disclosure have been described using specific terms, the specification and drawings are to be regarded in an illustrative rather than a restrictive sense in order to help understand the present disclosure. It is obvious to those skilled in the art that various modifications and changes can be made thereto without departing from the broader spirit and scope of the disclosure.

1. A discontinuous reception control method of a terminal in a wireless communication system, the method comprising:
measuring speed-related information of the terminal;
transmitting the measured speed-related information to a base station;
receiving discontinuous reception configuration information for dynamic discontinuous reception operation of the terminal from the base station in response to the speed-related information of the terminal; and
performing the discontinuous reception according to the received discontinuous reception configuration information.

2. The method of claim 1, wherein the discontinuous reception configuration information comprises a plurality of on-duration timers, a plurality of discontinuous reception inactivity timers, and a plurality of discontinuous reception cycles.

3. The method of claim 2, wherein the performing of the discontinuous reception comprises:
determining whether new data transmission/reception occurs during a predetermined period; and
performing, when the new data transmission/reception does not occurs during the predetermined period, the discontinuous reception with a short cycle on-duration timer, a short cycle discontinuous reception inactivity timer, and a long discontinuous reception cycle.

4. The method of claim 2, wherein the performing of the discontinuous reception comprises performing, when the new data transmission/reception occurs during the predetermined period, the discontinuous reception with a cycle on-duration timer, a long cycle discontinuous reception inactivity timer, and a short discontinuous reception cycle.

5. The method of claim 1, further comprising:
measuring channel quality of a serving cell; and
performing, when L3 filtered measurement result is greater than a first threshold value and instantaneous measurement result is greater than a second threshold value, the discontinuous reception with a long discontinuous reception cycle.

6. The method of claim 5, further comprising performing, when the L3 filtered measurement result is less than the first threshold value and the instantaneous measurement result is less than the second threshold value, the discontinuous reception with a short discontinuous reception cycle.

7. A terminal for controlling discontinuous reception in a wireless communication system, the terminal comprising:
a transceiver which transmits and receives to and from a base station; and
a controller which controls measuring speed-related information of the terminal, transmitting the measured speed-related information to a base station, receiving discontinuous reception configuration information for dynamic discontinuous reception operation of the terminal from the base station in response to the speed-related information of the terminal, and performing the discontinuous reception according to the received discontinuous reception configuration information.

8. The terminal of claim 7, wherein the discontinuous reception configuration information comprises a plurality of on-duration timers, a plurality of discontinuous reception inactivity timers, and a plurality of discontinuous reception cycles.

9. The terminal of claim 8, wherein the controller determines whether new data transmission/reception occurs during a predetermined period and controls performing, when the new data transmission/reception does not occurs during the predetermined period, the discontinuous reception with a short cycle on-duration timer, a short cycle discontinuous reception inactivity timer, and a long discontinuous reception cycle.

10. The terminal of claim 8, wherein the controller controls performing, when the new data transmission/reception occurs during the predetermined period, the discontinuous reception with a cycle on-duration timer, a long cycle discontinuous reception inactivity timer, and a short discontinuous reception cycle.

11. The terminal of claim 7, wherein the controller controls measuring channel quality of a serving cell and performing, when L3 filtered measurement result is greater than a first threshold value and instantaneous measurement result is greater than a second threshold value, the discontinuous reception with a long discontinuous reception cycle.

12. The terminal of claim 11, wherein the controller controls performing, when the L3 filtered measurement result is less than the first threshold value and the instantaneous measurement result is less than the second threshold value, the discontinuous reception with a short discontinuous reception cycle.
